(19) United States
(12) Patent Application Publication
(10) Pub. No.: US 2009/0001803 A1
(43) Pub. Date: Jan. 1, 2009

(54) Methods For Providing Vehicle Ballasting Weights

(76) Inventor: John S. Taylor, Commerce, MI (US)

Correspondence Address: 3M INNOVATIVE PROPERTIES COMPANY, PO BOX 33427, ST. PAUL, MN, 55133-3427, US

(21) Appl. No.: 12/160,375

(22) PCT Filed: Jan. 9, 2007
(86) PCT No.: PCT/US07/00355

§ 371 Date: Jul. 9, 2008

Related U.S. Application Data
(60) Provisional application No. 60/757,607, filed on Jan. 10, 2006.

(51) Int. Cl. B60B 27/00

(52) U.S. Cl. 301/5.21

(57) ABSTRACT

A method of providing a vehicle ballasting weight for balancing a portion of a vehicle. The method comprises providing an initial length of a vehicle ballasting weight material comprising a flexible polymeric matrix material filled with a high density particulate material, and severing an incremental length of the vehicle ballasting weight material from the initial length, where the incremental length corresponds to a desired mass for the vehicle ballasting weight.

### FIELD OF THE INVENTION

The present invention relates to methods and devices for providing weights used in vehicle ballasting applications, in particular, for providing weights used in balancing rotating portions of a vehicle and, more particularly, for providing weights used in balancing automobile or other vehicle wheels.

### BACKGROUND

Automotive wheel balancing devices or balancers currently use individual wheel balancing weights of varying sizes (i.e., weight), typically in increments of 5 grams or ⅛ ounces, and made of lead or other metals. In addition to being stored and applied separately, such individual conventional wheel weights require a different part number for each weight increment, and wheel diameter.

In an effort to avoid such problems with individual conventional weights, weights of the same size have been attached together along a length of adhesive tape. One or more of such taped wheel weights are removed from the tape and adhered to the desired location on the wheel, in accordance with the particular balancing requirements. One example of such a conventional tape of individual wheel balancing weights can be found in U.S. Pat. No. 6,364,421. A problem with such taped individual wheel weights is that the balancing process can only round up or down one of the individual weights on the tape, when providing the number of individual weights to be used on a wheel. This lack of precision adds error to the wheel balancing results.

The present invention provides one or more improvements in the art of vehicle wheel balancing, as well as in other ballasting applications.

### INVENTION SUMMARY

The present invention has one or more advantages which can include, for example, allowing for a reduction in part numbers, or only one part number, to be used regardless of the variety of weight sizes needed, which reduces inventory. The present invention can also have the advantage of allowing for the application of the exact weight required to balance the wheel, which results in improved tire performance and vehicle ride.

In accordance with a first aspect of the present invention, a method is provided for dispensing or otherwise providing a vehicle ballasting weight for balancing a portion of (e.g., a wheel or other rotating portion) of an automobile, other wheeled motor vehicle or other vehicle (e.g., a car, van, truck, bus, motorcycle, bicycle, airplane, trailer, etc.). The method comprises providing an initial finite or continuous length of a vehicle ballasting weight material comprising a flexible polymeric matrix material filled with a high density particulate material; and severing (e.g., by cutting or otherwise removing) an incremental length of the vehicle ballasting weight material from the initial length, wherein the incremental length corresponds to a desired weight or mass for the vehicle ballasting weight.

The vehicle ballasting weight material can be dimensioned or otherwise operatively adapted so as to be suitable (e.g., by being sufficiently loaded with the particulate material to provide a sufficient density) for use in balancing a wheel of an automobile (e.g., a car, van, truck, bus, etc.). The initial length of vehicle ballasting (e.g., wheel balancing) weight material can be substantially longer (e.g., 10, 20, 30, 40, 50, 60, 70, 80, 96, 100 or more times longer) than it is wide and substantially wider (e.g., 1, 2, 3, 4, 5, 6, 7, 8, 9, 10 or more times wider) than it is thick.

The vehicle ballasting weight material can have a density approximately equal to, somewhat less than, somewhat greater than or comparable to elemental lead, depending at least in part on size constraints for applying the weight material.

The method can further comprise measuring the incremental length of the vehicle ballasting weight material before said severing. It is desirable for the incremental length of vehicle ballasting weight material to be measurable with sufficient precision as to allow this length to be measured in increments that correspond to weight increments of less than 5 grams (g) or ⅛ ounce (oz). The initial length of vehicle ballasting weight material can be provided in a rolled, spooled or otherwise wound form. The initial length of vehicle ballasting weight material can be provided in a container having an opening through which an end of the initial length of vehicle ballasting weight material can be dispensed or otherwise removed out of the container, and the method can further comprise removing at least the incremental length of the vehicle ballasting weight material from the container, before said severing.

The initial length or incremental length of vehicle ballasting weight material can be backed with an adhesive suitable for permanently adhering or at least substantially adhering (i.e., the vehicle ballasting weight is bonded well enough to a desired portion of the vehicle to meet any applicable customer specifications and/or governmental regulations/requirements) the incremental length of the vehicle ballasting weight material to the vehicle. The initial length of vehicle ballasting weight material can be backed with an adhesive. The adhesive can be a pressure sensitive adhesive, which is desirably protected using a conventional release liner.

In accordance with a another aspect of the present invention, a method is provide for balancing a wheel of an automobile or other wheeled motor vehicle or other vehicle (e.g., a car, van, truck, bus, motorcycle, bicycle, airplane, trailer, etc.). The method comprises dispensing or otherwise providing a wheel weight as described above; and securing the wheel weight onto the wheel so as to balance the wheel. The securing step can comprise adhering the wheel weight to the wheel.

### BRIEF DESCRIPTION OF DRAWINGS

FIG. 1 is a perspective view of a length of adhesive-backed wheel weight material wound into a roll in accordance with the present invention; and

FIG. 2 is a perspective view of a device for measuring and cutting an initial length of wheel weight material into incremental lengths in accordance with the present invention.

### EXEMPLARY MODES FOR CARRYING OUT THE INVENTION

The present invention is directed to the dispensing of individual vehicle ballasting weight increments 10 that are cut or otherwise separated from a finite or continuous length of vehicle ballasting weight material 12. Such weight increments 10 are useful in vehicle ballasting applications such as, for example, balancing the wheels of an automobile or other vehicle. The weight material 12 is a high density polymer composite material comprising a flexible polymeric matrix material loaded or filled with a high density particulate material. The matrix material can comprise, for example, an elastomeric polymer material, and the high density particulate material can comprise, for example, stainless steel, tungsten and/or other metal particles. Examples of such a metal polymer composite material can be found in International Publication No. WO 2005/049714, which is incorporated by reference herein in its entirety. It has been found that various of the metal polymer composite materials described in this publication can be particularly useful in making the weight material 12 used in accordance with the present invention. Such metal polymer composite materials are particularly useful in providing individual vehicle ballasting weight increments 10, because such composite materials can exhibit one or more, and preferably all, of following properties, even when loaded with a level of high density particles that results in the composite having a density approaching, equaling or exceeding the density of the metal lead: (a) their ability to be readily extrudable with a desired crossectional profile, (b) their flexibility, and (c) the ease in which such materials can be cut.

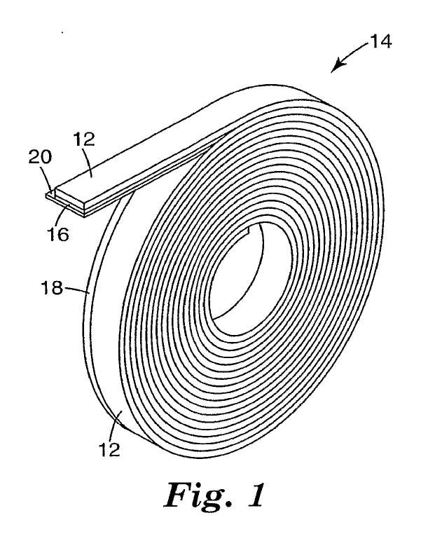

Referring to FIG. 1, it can be desirable for the length of weight material 12 to be in the form of an adhesive-backed vehicle ballasting weight assembly 14 that is wound into a roll. The weight assembly 14 includes an adhesive backing 16 protected by a release liner 18. The adhesive backing 16 can be, for example, a layer of pressure sensitive adhesive or other desired conventional adhesive (e.g., in the form of a coating or double-sided tape) that is compatible with the weight material 12 and the substrate (e.g., the rim of an automobile tire) on which the material 12 is be bonded (i.e., the adhesive is able to adequately bond to both the weight material 12 and the substrate). The liner 18 can be, for example, a silicon coated paper liner or other conventional release liner that is compatible with the adhesive 16 (i.e., the liner 18 will remain bonded so as to protect the adhesive 16 but is also readily removable when it is desirable to expose the adhesive 16). For wheel balancing applications, and other applications where the substrate to be bonded to is curved (i.e., has a simple or compound curvature), it is preferred that the adhesive 16 be in the form of a double-sided adhesive foam tape. In addition, for most if not all applications, the release liner 18 is preferably oversized, with a width that is wider than that of the weight material 12. In this way, the portion 20 of the liner 18 that extends beyond the longitudinal edge of the weight material 12 can be gripped when removing a length of the liner 18 from the adhesive 16.

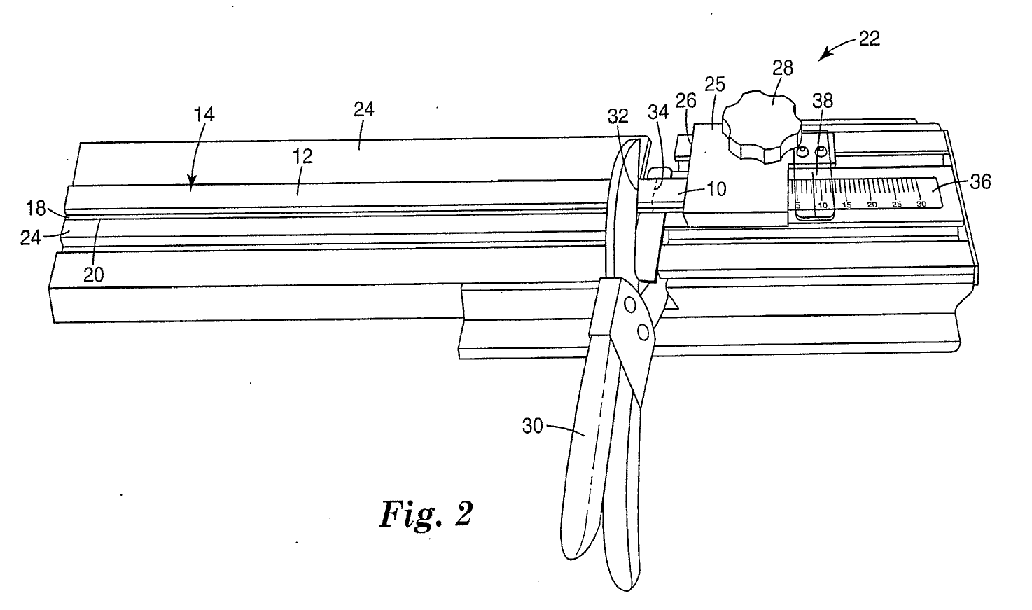

The present weight assembly 14 readily enables the use of the exact weight increment 10 required for the particular balancing application by simply cutting or otherwise separating the desired weight increment 10 from the length of weight assembly 14. Referring to FIG. 2, a basic device 22 that can be used to cut this exact weight increment 10, from the length of the assembly 14, may include a support surface 24 on which the assembly 14 can rest. The leading end of the length of assembly 14 is positioned, for example, by being slid along this surface 24, so as to contact a stop surface 26 of an adjustable stop 25. The stop 25 is operatively adapted so as to be slidable, or otherwise adjustable, lengthwise along the device 22, beyond the end of the support surface 24 (e.g., to the right of the surface 24 in the exemplary device 22 shown in FIG. 2). The stop 25 can be secured at a desired location on the device 22, beyond the support surface 24, for example, by tightening a screw 28 that passes through the stop 25 and into an underlying portion of the device 22, or by any other operative locking device or method. A cutting device 30 such as, for example, hand operated cutting snips or scissors, as shown, or a machine operated cutting device, is secured or otherwise disposed so as to cut the assembly 14, with a cutting edge 32, at a point (as indicated by phantom line 34) along its length corresponding to an incremental length 10 of the weight assembly 14 (i.e., an incremental weight) desired for a particular ballasting application.

Preferably, the cutting device 30 is fixed in place on the device 22, and the device 22 includes structure for accurately measuring the length of the assembly 14 that extends beyond the cutting edge 32 of the device 30 (i.e., the length of the incremental weight 10). As illustrated in FIG. 2, one mechanism for measuring the length corresponding to the desired mass of a particular weight 10, to be cut from the assembly 14, is to secure a scale 36 along the surface on which the stop 25 slides. As the stop 25 slides away from the cutting edge 32, a leading edge of the stop 25 moves along the scale 36. The increments on the scale 36 can be in length units and the scale 36 positioned so that movement of the stop 25 along the scale 36 indicates the distance between the cutting edge 32 and the stop surface 26. Alternatively, to avoid having to convert from a length measurement to a corresponding weight, the scale 36 can be calibrated so that each increment on the scale 36 is in weight units. To improve the weight measuring accuracy of the device 22, the stop 25 can include an indicator line 38 mounted on its leading end. It is desirable for the scale 36 to have length increments that are sufficiently precise as to allow the length of the weight 10 to be measured in length increments that correspond to weight increments of less than 5 grams (g) or ⅛ ounce (oz).

With this exemplary device 22, according to the present invention, the stop 25 and, thereby, the indicator line 38 can be secured at a location along the scale 36 corresponding to the desired mass or size of the severed weight 10, e.g., using the screw 28. The leading end of the weight assembly 14 can then be slide along the length of the support surface 24 and under the cutting edge 32, until the leading end of the weight assembly 14 hits the stop surface 26. The assembly 14 can then be cut to the desired length and, thereby, produce the required ballasting weight.

1. A method of providing a vehicle ballasting weight for balancing a portion of a vehicle, said method comprising:
providing an initial length of a vehicle ballasting weight material comprising a flexible polymeric matrix material filled with a high density particulate material; and
severing an incremental length of the vehicle ballasting weight material from the initial length,
wherein the incremental length corresponds to a desired mass for the vehicle ballasting weight.

2. The method according to claim 1, wherein the vehicle ballasting weight material is operatively adapted so as to be suitable for being used in balancing a rotating portion of a vehicle.

3. The method according to claim 1, wherein the vehicle ballasting weight material is operatively adapted so as to be suitable for being used in balancing a wheel of a wheeled vehicle.

4. The method according to claim 1, wherein the initial length of vehicle ballasting weight material is substantially longer than it is wide and substantially wider than it is thick.

5. The method according to claim 1, wherein the vehicle ballasting weight material has a density comparable to elemental lead.

6. The method according to claim 1, further comprising:
measuring the incremental length of the vehicle ballasting weight material before said severing.

7. The method according to claim 6, wherein the initial length of vehicle ballasting weight material has a leading end, said severing is performed with a cutting edge, and said measuring comprises disposing the leading end of the vehicle ballasting weight material against a stop surface located a distance from the cutting edge equal to the incremental length desired for the vehicle ballasting weight material.

8. The method according to claim 7, wherein the stop surface is adjustable to a plurality of distances from the cutting edge.

9. The method according to claim 7, wherein the stop surface is adjustable to a plurality of distances from the cutting edge, wherein each distance corresponds to an incremental length desired for the vehicle ballasting weight material.

10. The method according to claim 9, wherein the stop surface is adjustable to distances from the cutting edge with sufficient precision to allow the incremental length of the vehicle ballasting weight material to, be measured in length increments that correspond to weight increments of less than 5 grams.

11. The method according to claim 1, wherein the initial length of vehicle ballasting weight material is provided in a wound form.

12. The method according to claim 1, wherein the initial length of vehicle ballasting weight material is provided in a container having an opening through which an end of the initial length of vehicle ballasting weight material can be dispensed or otherwise removed out of the container, and said method further comprises:
removing at least the incremental length of the vehicle ballasting weight material from the container, before said severing.

13. The method according to claim 1, wherein the incremental length of vehicle ballasting weight material is backed with an adhesive.

14. The method according to claim 1, wherein the initial length of vehicle ballasting weight material is backed with an adhesive.

15. The method according to claim 13, wherein the adhesive is a pressure sensitive adhesive.

16. The method according to claim 1, wherein the flexible polymeric matrix material comprises an elastomeric polymeric material and the high density particulate material comprises metal particles.

17. The method according to claim 16, wherein the metal particles comprise tungsten particles.

18. As method of balancing a wheel of a wheeled vehicle, said method comprising:
providing an incremental length of vehicle ballasting weight material according to the method of claim 1; and
securing the incremental length of vehicle ballasting weight material onto the wheel so as to balance the wheel.

19. The method according to claim 18, wherein only one incremental length of vehicle ballasting weight material is required to balance the wheel.

20. The method according to claim 18, wherein said securing comprises adhering the incremental length of vehicle ballasting weight material to the wheel.
